(19) United States
(12) Patent Application Publication
(10) Pub. No.: US 2026/0227169 A1
(43) Pub. Date: Aug. 6, 2026

(54) METHODS AND APPARATUS TO MEASURE HOLE NORMALITY

(71) Applicant: The Boeing Company, Arlington, VA (US)

(72) Inventor: Edward John Batt, Boeme, TX (US)

(21) Appl. No.: 19/047,157

(22) Filed: Feb. 6, 2025

(51) Int. Cl. G01B 5/245; G01B 3/46; G01B 5/14

(52) U.S. Cl. CPC G01B 5/245; G01B 3/46; G01B 5/14

(57) ABSTRACT

Method and apparatus to measure hole normality are disclosed. An example apparatus for measuring a normality of an aperture relative to a surface includes a shaft to be inserted into the aperture of the surface, a body carrying the shaft, a carriage pivotable relative to the body, the carriage supporting a probe to contact the surface, and displacement indicator supported by the body, the displacement indicator to be moved by the carriage to measure a displacement of the probe as the body and the carriage are rotated about the shaft.

### FIELD OF THE DISCLOSURE

This disclosure relates generally to measuring components and, more particularly, to methods and apparatus to measure hole normality.

### BACKGROUND

Hole normality corresponds to the perpendicularity of a hole relative to a surface. Typically, hole normality is measured as an indication of structural integrity in certain applications, such as aerospace manufacturing. In known implementations, obtaining hole normality measurements can be a difficult task that can necessitate expensive and relatively large equipment. Further, known measurement methodology of hole normality can be time-consuming.

### BRIEF DESCRIPTION OF THE DRAWINGS

FIG. 1A depicts an example apparatus constructed in accordance with the teachings herein.

FIG. 1B is an exploded view of the example apparatus of FIG. 1A.

FIGS. 2A and 2B are views depicting the example apparatus of FIGS. 1A and 1B.

FIG. 3 is a flowchart representative of an example method and/or example machine readable instructions that may be executed, instantiated, and/or performed by example programmable circuitry.

FIG. 4 is a block diagram of an example processing platform including programmable circuitry structured to execute, instantiate, and/or perform the example machine readable instructions and/or perform the example operations of FIG. 3.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### SUMMARY

An example apparatus for measuring a normality of an aperture relative to a surface includes a shaft to be inserted into the aperture of the surface, a body carrying the shaft, a carriage pivotable relative to the body, the carriage supporting a probe to contact the surface, and a displacement indicator supported by the body, the displacement indicator to be moved by the carriage to measure a displacement of the probe as the body and the carriage are rotated about the shaft.

An example method for measuring a normality of an aperture relative to a surface includes inserting a shaft into the aperture of the surface, rotating a body supporting a displacement indicator about the shaft, a portion of the displacement indicator to be moved by a carriage as the body is rotated, the carriage having a probe to contact the surface at a distance from the aperture, and measuring a minimum displacement and a maximum displacement of the surface corresponding to rotation of the body about the shaft.

An example hole normality gauge includes a shaft to at least be partially inserted into a hole of a surface, a body supporting the shaft, a carriage pivotably coupled to the body, the carriage having a first end with a first surface probe and a second end with a second surface probe, and a displacement sensor supported by the body, the displacement sensor to measure a displacement of at least a portion of the carriage as the gauge is rotated about the shaft.

### DETAILED DESCRIPTION

Methods and apparatus to measure hole normality are disclosed. In certain applications, such as aerospace applications, characterizing normality of a hole or aperture can be an important parameter to be measured. Hole normality is generally measured in a lab environment. However, measuring hole normality in the field is desirable in a wide variety of applications. For example, measuring hole normality of a large object (e.g., a ground-based vehicle, an aircraft, etc.) in a lab environment is impractical. Further, measuring hole normality in relatively tight spaces of a vehicle (e.g., inside a fuselage of an aircraft, inside a compartment of an aircraft, etc.) can be complex and can even necessitate disassembling the vehicle for measurements. Measuring hole normality in known implementations can necessitate the use of complex and expensive electronic scanning equipment. Further, these known implementations are generally only effective at measuring relatively large diameter holes and may require specialized training. Some known implementations utilize relatively large and costly coordinate-measuring equipment to measure geometries of objects by sensing discrete points on a surface of an object with a probe. Such coordinate-measuring devices are typically located in a lab environment and cannot be easily transported.

Examples disclosed herein enable a gauge to measure hole normality and can accurately measure hole normality in a relatively quick manner. Further, operators with relatively minimal training can utilize examples disclosed herein, thereby saving time and labor associated with known methodologies. Further, examples disclosed herein are cost effective and relatively portable, in contrast to known implementations.

Examples disclosed herein utilize a shaft to be inserted in a hole of a surface. The shaft is supported by a body (e.g. an axis block). According to examples disclosed herein, a carriage, which is pivotable relative to the body, supports a probe (e.g. a surface probe) to contact the surface as the body and the carriage are rotated about the shaft. In turn, a displacement indicator mounted to and/or positioned by the body is utilized to measure the displacement of at least a portion of the carriage as the body and carriage are rotated. In particular, the carriage pivots as the probe displaces based on contours of the surface during rotation of the body and the carriage together, thereby enabling an operator to measure a minimum and maximum displacement of the probe. In turn, the hole normality can be calculated based on the minimum and maximum displacement values, for example. Examples disclosed herein can be adapted to a multitude of hole sizes (as well as surface sizes) and adapted to perform on a wide multitude of curvatures typically seen on vehicle panels. Examples disclosed herein can accurately measure hole normality to the nearest ten-thousandth of an inch on convex surfaces and the nearest thousandth of an inch on concave surfaces, which can be highly advantageous in numerous applications, including aerospace applications, for example.

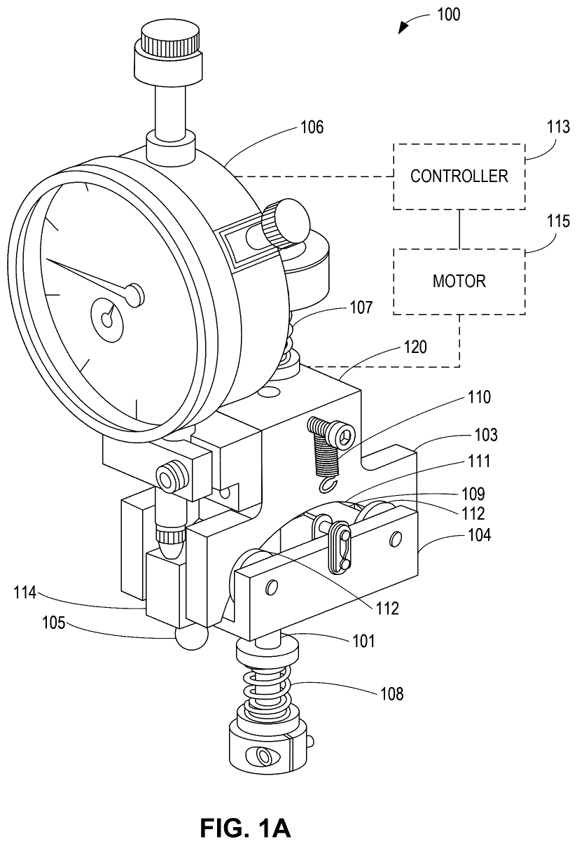

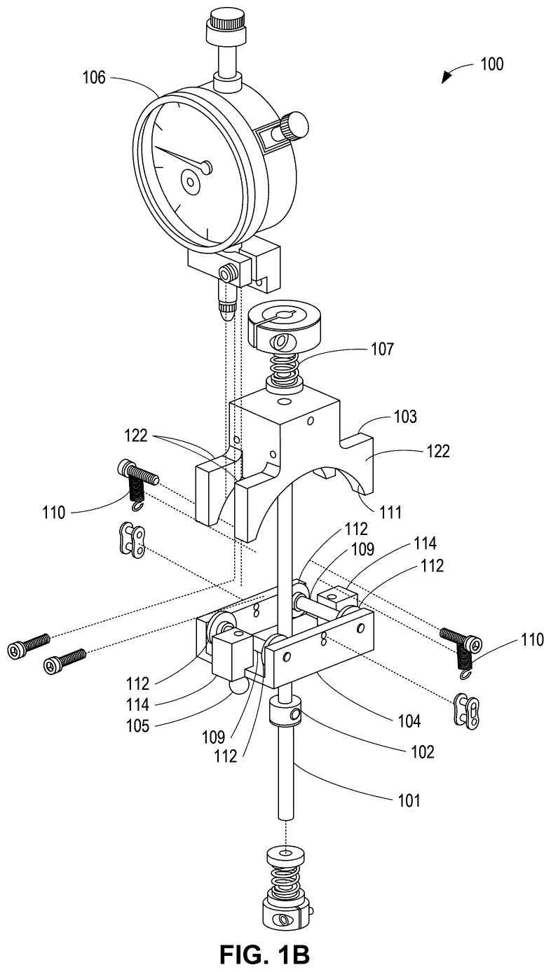

FIG. 1A depicts an example apparatus 100 for measuring hole normality relative to a surface constructed in accordance with the teachings herein, and FIG. 1B depicts an exploded view of the example apparatus 100 of FIG. 1A. Referring to FIGS. 1A and 1B, the example hole normality measurement apparatus 100 includes a shaft 101 supporting a surface contact 102, a body (e.g. an axis block) 103 supporting and/or aligning the shaft 101, and a carriage 104 supporting a probe (e.g., a surface probe, a contact probe, etc.) 105. The example apparatus 100 also includes a displacement indicator 106 supported by the body 103, a first spring 107, and a second spring 108. The carriage 104 of the illustrated example includes a roller axle 109 and a tension spring 110 operably coupling the body 103 and the carriage 104. The displacement indicator 106 of the illustrated example is a mechanical device. However, in other examples the indicator 106 may be a digital device.

The carriage 104 of the illustrated example includes two probes 105 located on opposite ends of the carriage 104, other examples may include any other appropriate number of probes (e.g. 1, 3, 4, 5, etc.). The probes 105 of the illustrated example are generally spherical to maintain a singular contact point with a surface. However, other example probes 105 may include flat probes, cylindrical probes, tapered probes, etc. Certain probes may be beneficial for surfaces with different curvatures.

In operation, the example probes 105 are in contact with the surface as the body 103 and the carriage 104 are rotated for measurement of the hole normality. Further, the body 103 includes contoured surfaces 111 in contact with the roller axle 109 to enable pivoting of the carriage 104 relative to the body 103 as the body 103 and carriage 104 are rotated together about the shaft 101. Further, in this example, guides 112 of the roller axle 109 at least partially constrain the carriage 104 as the carriage 104 pivots relative to the body 103. In other words, the pivoting of the carriage 104 relative to the body 103 is at least partially guided and/or constrained. According to examples disclosed herein, the displacement indicator 106 is moved by protrusions 114 of the carriage 104 as the carriage 104 pivots, thereby resulting in a displacement that can be measured by the indicator 106. In this example, the first spring 107 biases, moves and/or urges the body 103 and the carriage 104 against a first side of the surface and the second spring 108 biases, moves and/or urges the shaft 101 and surface contact 102 against a second side of the surface opposite the first side.

In this example, as can be seen in FIG. 1B, the body 103 includes a block 120 with four opposing arms 122. Particularly, two of the arms 122 extend from each lateral side of the block 120. In this example, each extending pair of the arms 122 are spaced apart to straddle the respective protrusions 114 of the carriage 104.

In some examples, the hole normality measuring apparatus 100 may include an example controller 113 and/or an example motor 115. For example, when the hole normality measuring apparatus 100 is an automated or partially automated system, the controller 113 may be instantiated to perform rotation of the body 103 and the carriage 104 via the motor 115. Further, the controller 113 may be instantiated to electronically and/or automatically measure minimum and maximum displacement of the surface via the indicator 106 and calculate a hole normality value based on the minimum and maximum displacement of the surface.

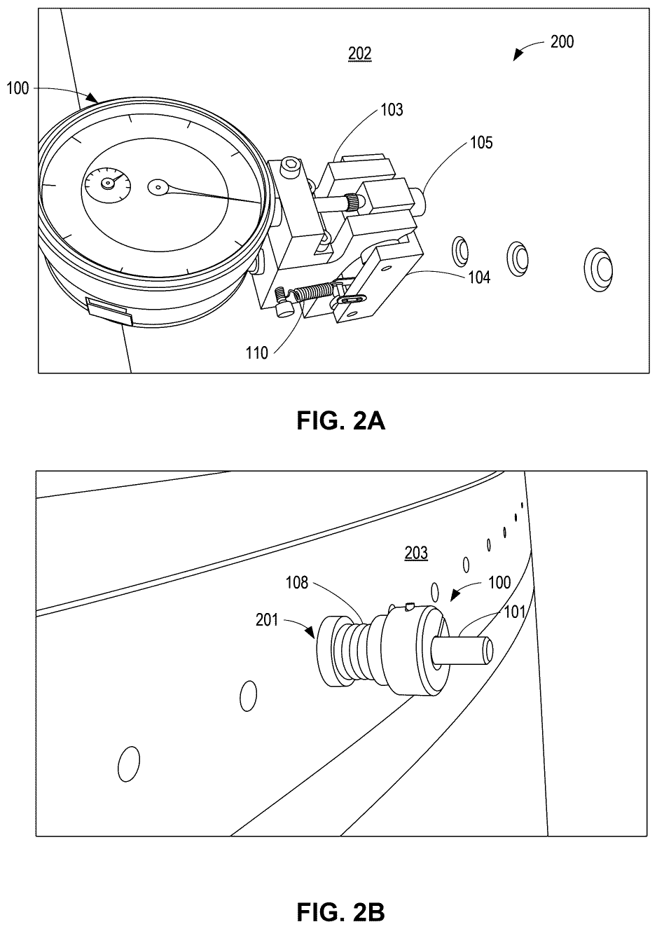

FIGS. 2A and 2B depict the example hole normality measuring apparatus 100 of FIG. 1 being utilized on a surface 200. In the example of FIG. 2A, the shaft 101 is inserted into a hole 201 of a first side 202 of the surface 200 to be measured. Referring to FIG. 2B, the second spring 108 is coupled to the shaft 101 on a second side 203 of the surface 200 that is opposite the first side 202. In other words, FIGS. 2A and 2B depict opposing sides of the surface 200 with the hole normality apparatus 100 coupled thereto.

When measuring hole normality, the first spring 107 and the second spring 108 are used to tension the shaft 101, the body 103, and the carriage 104 to the surface 200. According to examples disclosed herein, a force is applied to tension the second spring 108 against the second side 203 of the surface 200 and the surface contact 102 is coupled to the shaft 101 on the first side 202 of the surface 200 to maintain the second spring 108 under tension. In some examples, the second spring 108 may be replaced with a shaft 101 including at least a threaded portion. In particular, the threaded portion can thread into the hole 201, thereby enabling potential removal of the second spring 108. In turn, the apparatus 100 is supported by the shaft 101 and the first spring 107 is utilized to bias the apparatus 100 against the first side of the surface 200.

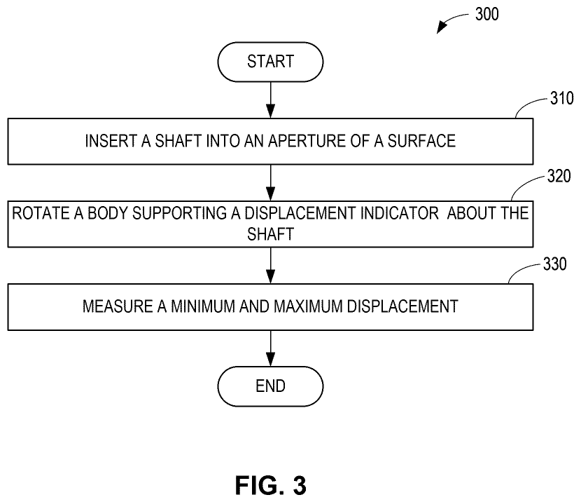

FIG. 3 is a flowchart representative of an example method 300 to measure hole normality. The method 300 may include instructions and/or example operations 300 that may be executed, instantiated, and/or performed by programmable circuitry to implement the controller 113 of FIG. 1, for example. While the method 300 of FIG. 3 may be described with reference to the execution of machine readable instructions by programmable circuitry, it should be appreciated that some or all of the blocks of this method can be performed manually by a user. The example method 300 begins at block 310 as a shaft 101 is inserted into an aperture or hole of the surface. In examples where the aperture is a threaded aperture, the shaft 101 may include a first threaded portion to be fastened to a corresponding second threaded portion corresponding to the hole.

At block 320, the body 103 supporting the displacement indicator 106 is rotated about the shaft 101 along with the carriage 104. In some examples, the controller 113 directs the motor 115 to rotate the body 103 supporting the displacement indicator 106 about an axis of rotation defined by the shaft 101. In some examples, the probe 105 of the carriage 104 may be positioned at a distance from the aperture or hole of the surface.

At block 330, minimum and maximum displacements of the surface probe 105 are measured via the displacement indicator 106. For example, the minimum and maximum displacements correspond to one full rotation of the body 103 and the carriage 104. However, any other appropriate number of rotations can be implemented instead (e.g., two, three, four, five, . . . ten . . . twenty, etc.). In some examples, the controller 113 is utilized to measure a minimum and maximum displacement of the surface probe 105 contacting the surface.

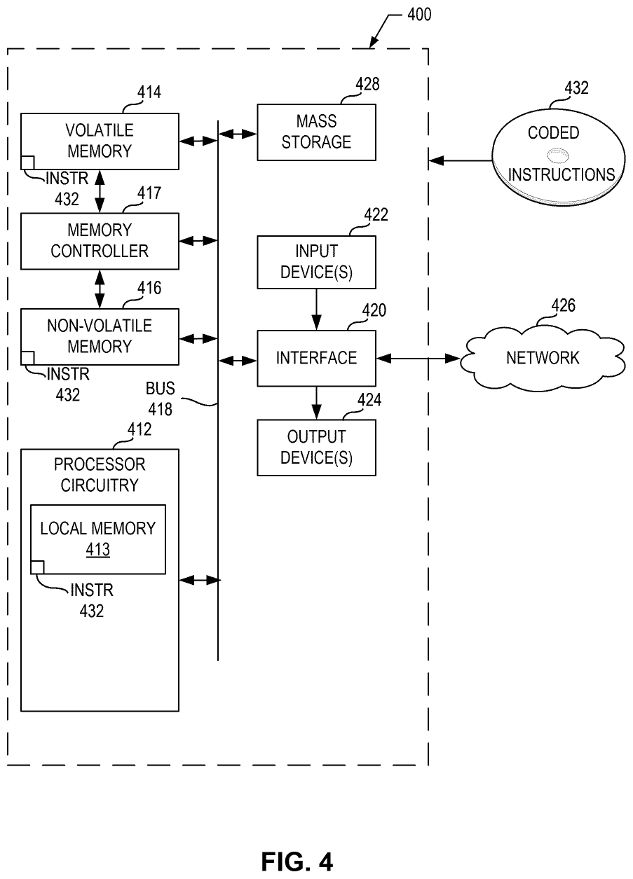

FIG. 4 is a block diagram of an example programmable circuitry platform 400 structured to execute and/or instantiate the example machine-readable instructions and/or the example operations of FIG. 3 to implement the controller 113 of FIGS. 1A and 1B. The programmable circuitry may be utilized to measure and record the minimum and maximum displacements of a surface as the body 103 and the carriage 104 are rotated about the shaft 101. Further, the programmable circuitry may be utilized to control the motor 115 to rotate the body 103 and the carriage 104 about the shaft 101. The programmable circuitry platform 400 can be, for example, a personal computer, a workstation, a mobile device (e.g., a cell phone, a smart phone, a tablet such as an iPad™), a headset (e.g., an augmented reality (AR) headset, a virtual reality (VR) headset, etc.) or other wearable device, or any other type of computing and/or electronic device.

The programmable circuitry platform 400 of the illustrated example includes programmable circuitry 412. The programmable circuitry 412 of the illustrated example is hardware. For example, the programmable circuitry 412 can be implemented by one or more integrated circuits, logic circuits, FPGAs, microprocessors, CPUs, GPUs, DSPs, and/or microcontrollers from any desired family or manufacturer. The programmable circuitry 412 may be implemented by one or more semiconductor based (e.g., silicon based) devices.

The programmable circuitry 412 of the illustrated example includes a local memory 413 (e.g., a cache, registers, etc.). The programmable circuitry 412 of the illustrated example is in communication with main memory 414, 416, which includes a volatile memory 414 and a non-volatile memory 416, by a bus 418. The volatile memory 414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 416 may be implemented by flash memory and/or any other desired type of memory device. Access to the main memory 414, 416 of the illustrated example is controlled by a memory controller 417. In some examples, the memory controller 417 may be implemented by one or more integrated circuits, logic circuits, microcontrollers from any desired family or manufacturer, or any other type of circuitry to manage the flow of data going to and from the main memory 414, 416.

The programmable circuitry platform 400 of the illustrated example also includes interface circuitry 420. The interface circuitry 420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 420. The input device(s) 422 permit(s) a user (e.g., a human user, a machine user, etc.) to enter data and/or commands into the programmable circuitry 412. The input device(s) 422 can be implemented by, for example, a camera (still or video), a keyboard, a button, a mouse, a touchscreen, a trackpad, a trackball, and/or an isopoint device.

One or more output devices 424 are also connected to the interface circuitry 420 of the illustrated example. The output device(s) 424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 420 of the illustrated example, thus, typically includes a graphics driver card, a graphics driver chip, and/or graphics processor circuitry such as a GPU.

The interface circuitry 420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 400 of the illustrated example also includes one or more mass storage discs or devices 428 to store firmware, software, and/or data. Examples of such mass storage discs or devices 428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 432, which may be implemented by the machine readable instructions of FIG. 3, may be stored in the mass storage device 428, in the volatile memory 414, in the non-volatile memory 416, and/or on at least one non-transitory computer readable storage medium such as a CD or DVD which may be removable.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

Example 1 includes an apparatus for measuring a normality of an aperture relative to a surface including a shaft to be inserted into the aperture of the surface, a body carrying the shaft, a carriage pivotable relative to the body, the carriage supporting a probe to contact the surface, and a displacement indicator supported by the body, the displacement indicator to be moved by the carriage to measure a displacement of the probe as the body and the carriage are rotated about the shaft.

Example 2 includes the apparatus of example 1, further including a spring operably coupling the body to the carriage.

Example 3 includes the apparatus of example 1, further including a spring coupled to the shaft to move the shaft toward the surface.

Example 4 includes the apparatus of example 3, wherein the spring is a first spring and further including a second spring coupled to the shaft to move the body and the carriage toward the surface.

Example 5 includes the apparatus of example 1, wherein the displacement indicator is a digital indicator,

Example 6 includes the apparatus of example 1, wherein the probe is a first probe on a first side of the carriage and further including a second probe on a second side of the carriage opposite of the first side.

Example 7 includes the apparatus of example 1, wherein the probe exhibits a spherical geometry.

Example 8 includes the apparatus of example 1, further including circuitry to calculate a normality of the aperture based on a maximum displacement of the probe and a minimum displacement of the probe, the maximum displacement and the minimum displacements corresponding to at least one rotation of the body and the carriage.

Example 9 includes a method for measuring a normality of an aperture relative to a surface including inserting a shaft into the aperture of the surface, rotating a body supporting a displacement indicator about the shaft, portion of the displacement indicator to be moved by a carriage as the body is rotated, the carriage having a probe to contact the surface at a distance from the aperture, and measuring a minimum displacement and a maximum displacement of the surface, corresponding to rotation of the body about the shaft.

Example 10 includes the method of example 9, further including, by executing instructions with at least one processor, calculating an aperture normality based on the minimum displacement and the maximum displacement of the surface.

Example 11 includes the method of example 9, further including moving the shaft to contact the surface via a spring.

Example 12 includes the method of example 11, wherein the spring is a first spring and further including moving the body and the carriage toward the surface via a second spring.

Example 13 includes the method of example 9, wherein rotating the body includes causing a motor to rotate the body about the shaft.

Example 14 includes the method of example 9, further including operably coupling the body to the carriage with a tension spring.

Example 15 includes a hole normality gauge including a shaft to at least be partially inserted into a hole of a surface, a body supporting the shaft, a carriage pivotably coupled to the body, the carriage having a first end with a first surface probe and a second end with a second surface probe, and a displacement sensor supported by the body, the displacement sensor to measure a displacement of at least a portion of the carriage as the gauge is rotated about the shaft.

Example 16 includes the gauge of example 15, wherein the first and second surface probes are spherical.

Example 17 includes the gauge of example 15, further including a spring operably coupled between the shaft and the body to move the shaft to contact the surface.

Example 18 includes the gauge of example 17, wherein the spring is a first spring, further including a second spring to move the body and the carriage toward the surface.

Example 19 includes the gauge of example 15, further including a tension spring operably coupling the body to the carriage.

Example 20 includes the gauge of example 15, further including machine readable instructions and programmable circuitry to execute the machine readable instructions to calculate a normality of a hole based on the maximum displacement and the minimum displacement.

From the foregoing, it will be appreciated that example systems, apparatus, articles of manufacture, and methods have been disclosed that enable measurement of hole normality.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus for measuring a normality of an aperture relative
to a surface, the apparatus comprising:
a shaft to be inserted into the aperture of the surface;
a body carrying the shaft;
a carriage pivotable relative to the body, the carriage supporting a probe to contact the surface; and
a displacement indicator supported by the body, the displacement indicator to be moved by the carriage to measure a displacement of the probe as the body and the carriage are rotated about the shaft.

2. The apparatus of claim 1, further including a spring operably coupling the body to the carriage.

3. The apparatus of claim 1, further including a spring coupled to the shaft to move the shaft toward the surface.

4. The apparatus of claim 3, wherein the spring is a first spring and further including a second spring coupled to the shaft to move the body and the carriage toward the surface.

5. The apparatus of claim 1, wherein the displacement indicator is a digital indicator.

6. The apparatus of claim 1, wherein the probe is a first probe on a first side of the carriage, and further including a second probe on a second side of the carriage opposite of the first side.

7. The apparatus of claim 1, wherein the probe exhibits a spherical geometry.

8. The apparatus of claim 1, further including circuitry to calculate a normality of the aperture based on a maximum displacement of the probe and a minimum displacement of the probe, the maximum and the minimum displacements corresponding to at least one rotation of the body and the carriage.

9. A method for measuring a normality of an aperture relative to a
surface, the method comprising:
inserting a shaft into the aperture of the surface;
rotating a body supporting a displacement indicator about the shaft, a portion of the displacement indicator to be moved by a carriage as the body is rotated, the carriage having a probe to contact the surface at a distance from the aperture; and
measuring a minimum displacement and a maximum displacement of the surface corresponding to rotation of the body about the shaft.

10. The method of claim 9, further including, by executing instructions with at least one processor, calculating an aperture normality based on the minimum displacement and the maximum displacement of the surface.

11. The method of claim 9, further including moving the shaft to contact the surface via a spring.

12. The method of claim 11, wherein the spring is a first spring and further including moving the body and the carriage toward the surface via a second spring.

13. The method of claim 9, wherein rotating the body includes causing a motor to rotate the body about the shaft.

14. The method of claim 9, further including operably coupling the body to the carriage with a tension spring.

15. A hole normality gauge comprising:
a shaft to at least be partially inserted into a hole of a surface;
a body supporting the shaft;
a carriage pivotably coupled to the body, the carriage having a first end with a first surface probe and a second end with a second surface probe; and
a displacement sensor supported by the body, the displacement sensor to measure a displacement of at least a portion of the carriage as the gauge is rotated about the shaft.

16. The gauge of claim 15, wherein the first and second surface probes are spherical.

17. The gauge of claim 15, further including a spring operably coupled between the shaft and the body to move the shaft to contact the surface.

18. The gauge of claim 17, wherein the spring is a first spring, and further including a second spring to move the body and the carriage toward the surface.

19. The gauge of claim 15, further including a tension spring operably coupling the body to the carriage.

20. The gauge of claim 15, further including:
machine readable instructions; and
programmable circuitry to execute the machine readable instructions to calculate a normality of the hole based on the maximum displacement and the minimum displacement.
